(19) United States
(12) Patent Application Publication
(10) Pub. No.: US 2002/0026747 A1
(43) Pub. Date: Mar. 7, 2002

(54) Substance dispensing conserver

(76) Inventors: Bradley R. Howe, Gresham, OR (US); Norman L. Hinote, Gresham, OR (US)

Correspondence Address: DELLETT AND WALTERS, 310 S.W. FOURTH AVENUE, SUITE 1101, PORTLAND, OR, 97204, US

(21) Appl. No.: 09/944,752

(22) Filed: Aug. 31, 2001

Related U.S. Application Data
(60) Provisional application No. 60/229,769, filed on Sep. 1, 2000.

(51) Int. Cl. A01G 29/00

(52) U.S. Cl. 47/48.5

(57) ABSTRACT

A substance dispensing conserver includes a container with an outer cover non-permeable to water flow over a period of time, but ultimately the cover is biodegradable. Within the interior of the container, the substance to be dispensed is provided, with a diffusion member for enabling the substance to leach or diffuse out of the container.

### BACKGROUND OF THE INVENTION

This invention relates to application of substances, and more particularly, to the application of fertilizer, herbicides, insecticides, fungicides and other agricultural substances.

Current methods of fertilizing growing plants include application of fertilizer to the soil surface, placement of the fertilizer within the root zone, and foliar applications. Fertilizers are moved within the soil by two processes, mass flow and capillary action. Since the application environment includes an aqueous component, diffusion of the fertilizer within the environments also takes place. Mass flow of nutrients occurs when the fertilizer nutrients dissolve in water and are carried along by the movement of the soil water. Capillary action is more localized, wherein water adheres to surfaces and the property of adhesion leads to small movements of water and dissolved nutrients.

Known methods of fertilizing (with the exception of direct nutrient injections to plant tissue) rely upon the mass flow of the water to move nutrients to the plant roots. The consequences of subjecting the nutrients to the mass flow results in loss of nutrients from the intended target. Run-off, either across the surface of the application site or that run-off which flows through the ground will carry nutrients with it, away from the plant that is to be fertilized. The runoff typically will carry the fertilizer to undesired locations, resulting in pollution.

Another limitation of having fertilizers rely upon mass flow is that if concentrations of the fertilizer are too high, the mass flow of nutrients will expose the roots of the plants being fertilized to nutrient levels beyond their threshold to tolerate, typically resulting in damage to the plant. Such damage may result in slowed or stunted growth, or even death of the plant.

In the container nursery industry, where plants are grown in individual or mass containers, for ultimate sale to the consumer in the container, it is desirable to fertilize the containers in a manner to allow as much nutrients to go to the plant as possible, while minimizing the waste of nutrients going out the bottom of the containers with excess water.

In a given application, greater than 50% of the fertilizer applied according to prior art methods will be lost to diffusion, ending up in the ground water or nearby bodies of water. Such loss of fertilizer into the ground water and bodies of water is undesirable at best, and can result in significant pollution problems in large scale applications such as commercial nursery operations.

Also, applying the fertilizer or other substances (such as insecticides) exposes the person making the application to the substances. In the case of insecticides, fungicides, fertilizers, or other substances, such exposure is not desirable, as it can lead to health problems over time.

U.S. Pat. No. 5,212,904, FERTILIZING APPARATUS, addresses some of these problems, by providing a fertilizing apparatus meant to contain the fertilizer near a plant. The apparatus employs a container that is placed in the ground next to a plant. However, the body of the apparatus is made from PVC or polystyrene. These types of material are not readily biodegradable, and in commercial applications, it may not be cost effective to remove them. When the plant is container grown, the bodies may tend to be unsightly, reducing consumer appeal. Some consumers may object to the non-biodegradable aspect of the device.

Corresponding to the case with fertilizers, application of insecticides, fungicides and the like tends to result in the applied substances traveling beyond the application site, possibly resulting in pollution. Especially when applied by spraying, insecticides and fungicides will tend to drift beyond the application site. Therefore, systemic application is often employed, wherein the insecticide or fungicide is delivered to the roots of the plant for uptake by the plant. However, as in the case of fertilizer application, the systemic insecticide/fungicide will be carried from the intended target, resulting in potential contamination of ground water or bodies of water, or of unintended application of the systemic to other nearby plants.

### SUMMARY OF THE INVENTION

In accordance with the invention, a substance dispensing conserver includes a container having an outer cover that is non-permeable to water flow in the short term, but is ultimately biodegradable. Within the interior of the container, the substance to be dispensed is provided. At least one portion of the container includes a diffusion member for enabling the substance to leach or diffuse out of the container.

Accordingly, it is an object of the present invention to provide an improved substance dispensing conserver apparatus.

It is a further object of the present invention to provide an improved fertilizer conserving dispensing device for slow release of fertilizer to a plant.

It is yet another object of the present invention to provide an improved substance dispensing conserver for application of fungicide.

It is yet another object of the present invention to provide an improved substance dispensing conserver for application of insecticides.

It is a further object of the present invention to provide an improved substance dispensing conserver for application of biostimulants.

It is a further object of the present invention to provide an improved substance dispensing conserver for application of mycorrhizal fungi.

It is another object of the present invention to provide an improved substance dispensing conserver for application of insecticide.

Another object of the present invention is to provide an improved substance dispensing conserver for systemic application of substances.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a perspective view of a substance dispensing conserving apparatus according to the invention as viewed from above;

FIG. 2 is a perspective view of the substance dispensing conserving apparatus of FIG. 1, but as viewed from below;

FIG. 3 is a sectional view of the substance dispensing conserving apparatus, taken along line 3-3 of FIG. 1;

FIG. 4 is a sectional view of an alternate substance dispensing conserving apparatus employing multiple substance formulations;

FIG. 5 is an alternate embodiment of the substance dispensing conserving apparatus, wherein a seed is provided together with a growing medium or growth enhancing substance; and

FIG. 6 is an environmental view showing the substance dispensing conserving apparatus in use in a container.

### DETAILED DESCRIPTION

The system according to a preferred embodiment of the present invention comprises an apparatus and method for conserving the application of substances, typically used in agricultural applications.

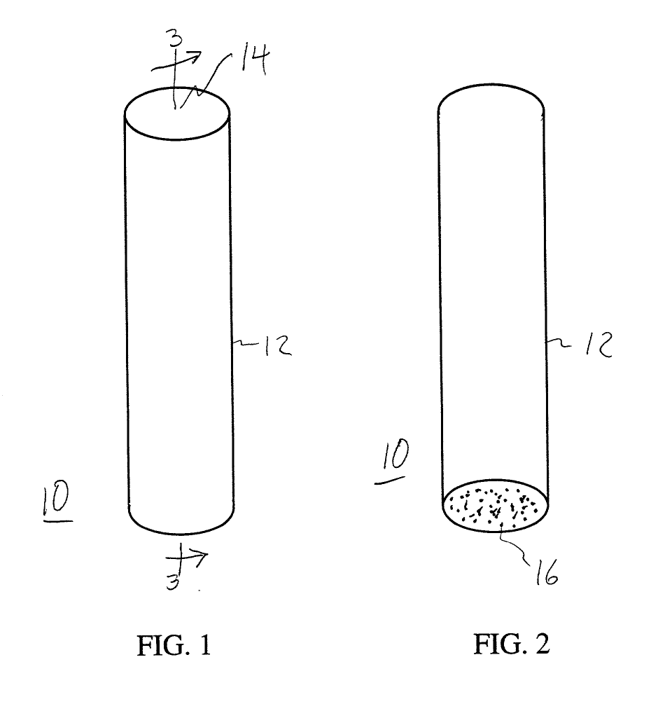

Referring to FIG. 1, a perspective view of a substance dispensing conserving apparatus 10 according to the invention as viewed from above the apparatus, in a preferred embodiment, a generally cylindrical container 12 is provided. The top end of the container 12 is preferably closed. Referring to FIG. 2, which is a perspective view of the apparatus of FIG. 1, as viewed from below the apparatus, at the bottom end of the container 14, a permeable closure member 16 is provided. In the preferred embodiment, container 12 is constructed, on its outer surfaces, of a material that is non-permeable to water flow, at least initially. Suitable materials for the body of the container comprise, for example, paper, craft paper, cardboard material, recycled paper or newspapers, which may be spiral wound as an outer covering over any suitable core material. Other materials are wood (hard or soft), bamboo, clay, ceramic, natural resins, silk, cotton, paper pulp, pressed compost, peat moss, corn husks, gelatin, bioplastic, cellophane, cellulose, leather, perlite, vermiculite, coconut husks, felt, sawdust (preferably compressed), chitin, sea shells, jute fiber, burlap, natural rubber, gypsum, reeds, molded fiber, corn stalk, and bone (such as, e.g., chicken bone). Any other biodegradable substance may be substituted as desired. These materials are initially relatively impervious to water passing therethrough, but will ultimately biodegrade. A coating, such as wax or glassine may be provided, to extend the period of water imperviousness. Closure member 16 is suitably, porous to allow water to pass therethrough. Suitable materials for use as the closure member are, for example, organic material such as peat moss. Also, the closure member can be laced with hormones, biostimulants and fertilizers, if desired.

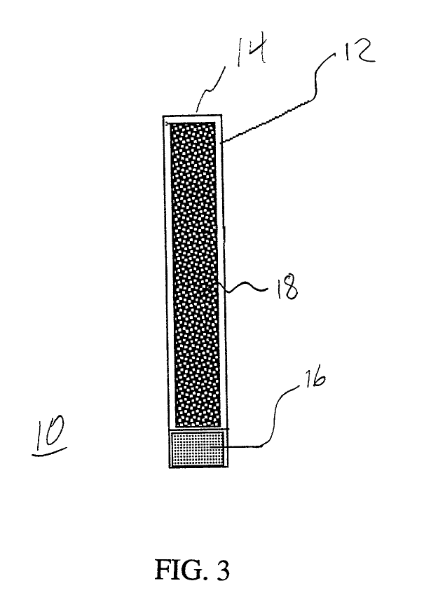

Referring now to FIG. 3, a sectional view of the substance dispensing conserving apparatus, taken along line 3-3 of FIG. 1, it may be observed that the container 12 defines an interior space containing the substance 18 to be dispensed. The closure member 16 is suitably defined as a plug, closing the open bottom end of the container. The substance 18 is delivered to the outside of the container through the closure member 16 via capillary action and simple diffusion. Closure member 16 is a low permeability closure (with respect to water), but is of substantially higher permeability than the outer covering of the container 12 (which is preferred to be relatively impermeable)

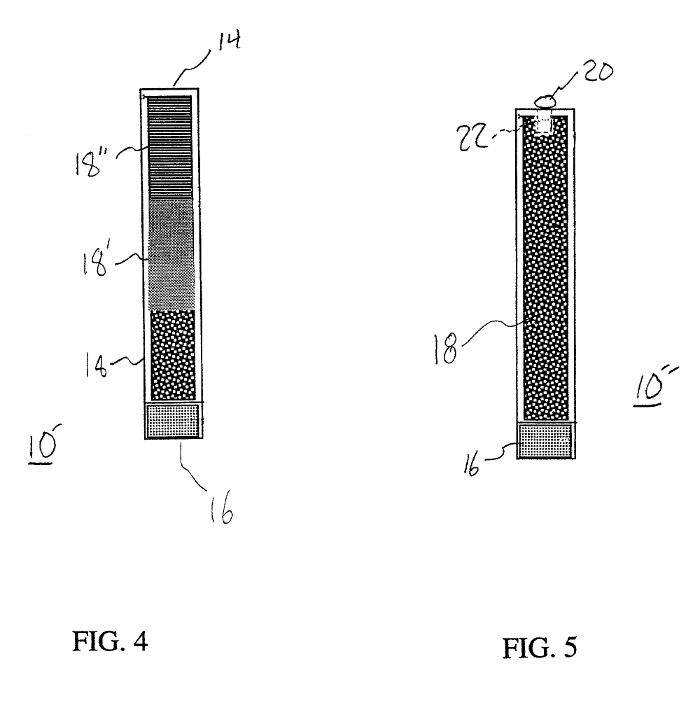

Substance 18 is suitably a concentrated fertilizer, for example. Multiple formulations may be employed, as illustrated in FIG. 4, wherein different concentrations or formulations 18, 18′ and 18″ of fertilizer or other substances are provided in segmented layers within the interior of the container. Since the container walls are relatively water impermeable, the fertilizer will be delivered through the closure member 16, resulting in the lowermost layer 18 being delivered first. Later, after some period of time has passed and most of layer 18 has been dispensed, layer 18′ will next begin to diffuse through the closure member. Finally, after layer 18′ is finished, layer 18″ will be dispensed. Layer 18 may comprise, for example, a fertilizer formulation suited for an early stage of plant growth, while layers 18′ and 18″ may be formulated for later stages of growth. For example, layer 18 may be intended to provide nutrients for maximizing green leafy growth, while layers 18′ and 18″ can be formulated to encourage flowering, after the plant has reached a certain level of maturity.

Another formulation of the various layers 18 includes the use of polyacrilamide gels, wherein the gels have been supersaturated with fertilizers (or pesticides, fungicides, herbicides, etc.), dehydrated and packed into the container. The purpose of the gels is to regulate the diffusion of fertilizers or other substances from the substance dispensing conserver. The use of the gels results in a consistent flow of nutrients, as well as providing the property of stopping nutrient flow under high soil water conditions. This stopping occurs as the polyacrilamide gels uptake water to stay in balance with the soil moisture levels. Nutrient flow begins again when soil moisture levels drop.

While the embodiment illustrated in FIG. 4 employs segmented layers, multiple formulations may also be substantially homogeneously mixed as well, rather than in discrete segments.

Referring now to FIG. 5, a sectional view of an alternate embodiment of the substance dispensing conserving apparatus, a seed (or seeds) 20 is provided a the top end of the container 12′. The seed may be attached to the exterior of the container, or, may be placed in a seed-receiving aperture 22 (illustrated in phantom) defined in the top of the container. The substance within the container may suitably be a fertilizer or other substances noted herein, or, may include a growing medium or growth enhancing substance.

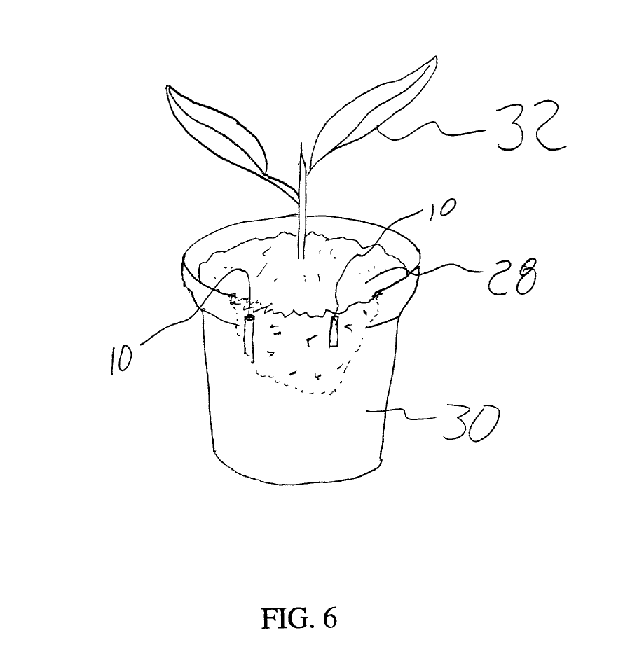

FIG. 6 is an environmental view, illustrating use of the substance conserving dispenser according to the invention. In use, the dispenser is placed in the soil 28 of a plant container 30. The dispenser may be driven into the soil by use of a hammer or the like, if necessary. Ideally, the dispenser is placed so that it is completely buried below the top surface of the soil, although it will function if a portion is sticking above the surface. The plant 32 is thereby nourished. As time goes on, additional dispensers may be added to the soil, to supply different substances as desired. Ultimately, the dispenser container will biodegrade, after it has finished its useful dispensing life. Thus, it is not necessary to remove the dispenser.

The apparatus according to the invention allows fertilizers, systemic insecticides, fungicides and other substances to move into the soil via capillary/diffusion movements. The concentrated fertilizer, insecticide, fungicide or other substance is not exposed to the mass flow of water driven by precipitation and gravity, reducing the likelihood of the substance becoming a pollutant in the water table or nearby bodies of water. Also, since the substance remains inside of a container that is not opened, persons applying the substance are not exposed to the substance. Other substances that may be dispensed are biostimulants, mycorrhizal fungi and the like. The substances can be organic or inorganic. Thus, a consistent supply of fertilizers, nutrients, insecticides, fungicides, or other substances is delivered in proportion to soil moisture levels. In accordance with the invention, fertilizer application supplying nutrients in this manner for multiple years may be achieved.

Plant roots posses a growth characteristic known as chemotaxis. Chemotaxis occurs when more energy is diverted to roots that either bring in more water or more nutrients. More root growth takes place in those roots to take advantage of the water or nutrient source. With the constant supply of nutrients provided by the substance dispensing conserver, root growth will in essence grow to the appropriate concentration zone of nutrients emanating from the container. The end result is an even supply of nutrients to the plant with much less loss of nutrients to the environment. A highly efficient manner of delivering nutrients to plants is thereby achieved, via a biodegrading container.

In an embodiment adapted for container use, the dispensing conserver apparatus 10 is suitably 3 inches (7.6 cm) long and approximately one half inch (1.3 cm) diameter. Other sizes are employed for different uses. For example, for use as a tree fertilizer dispenser in the ground, the container may be longer and have a larger diameter, to contain and release a larger dose of fertilizer than would be desired in a smaller container application. Longer containers may be employed for longer term dispensing, or to accommodate a different substance that may dispense more quickly than other substances. A shorter version, suitably one inch (2.5 cm) long is adapted for use in house plants, or, for situations where the substance is to be dispensed over a shorter duration of time. The dispensing conserver apparatus 10 may be color coded to differentiate the type of fertilizer, insecticide, fungicide or other substance contained therewithin. Temperature related release fertilizers are also suitably employed as the substance in the apparatus. In such case, the color coding can be employed to indicate the temperature range over which release occurs, as well as indicating the formulation. While the preferred shape of the apparatus is cylindrical or tube-like, other geometries can also be employed.

In alternative embodiments, different geometries can be used for the body of the apparatus to indicate different formulations or applications. For example, fertilizers may employ the cylindrical shaped body, while insecticides can employ a triangular or square shaped body, etc. Also, the cylindrical body may be perforated so that the substance contained therein may be more readily dispensed, or to allow the plant's roots to grow through the perforations. Such perforations may be more suitably desirable when the substance is a systemic application substance.

While plural embodiments of the present invention have been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. A substance dispensing device comprising:
a biodegradable member for containing the substance to be dispersed; and
a delivery member through which the substance is dispensed.

2. The substance dispensing device according to claim 1, wherein the substance to be dispensed comprise a fertilizer.

3. The substance dispensing device according to claim 1, wherein the substance to be dispensed comprise an insecticide.

4. The substance dispensing device according to claim 1, wherein the substance to be dispensed comprise a fungicide.

5. The substance dispensing device according to claim 1, wherein the substance to be dispensed comprise an insecticide.

6. The substance dispensing device according to claim 1, wherein the substance to be dispensed comprise a biostimulant.

7. The substance dispensing device according to claim 1, wherein the substance to be dispensed comprise a mycorrhizal fungi.

8. The substance dispensing device according to claim 1, wherein the biodegradable member is selected from the group consisting of: paper, craft paper, cardboard material, recycled paper, recycled newspaper, hard wood, soft wood, bamboo, clay, ceramic, natural resins, silk, cotton, paper pulp, pressed compost, peat moss, corn husks, gelatin, bioplastic, cellophane, cellulose, leather, perlite, vermiculite, coconut husks, felt, sawdust, chitin, sea shells, jute fiber, burlap, natural rubber, gypsum, reeds, molded fiber, corn stalk, and bone.

9. The substance dispensing device according to claim 1, wherein the biodegradable member includes an exterior coating to provide water imperviousness properties thereto.

10. The substance dispensing device according to claim 9, wherein said exterior coating comprises a wax.

11. The substance dispensing device according to claim 1, wherein said delivery member comprises a diffusion member.

12. The substance dispensing device according to claim 1, wherein said delivery member comprises peat moss.

13. The substance dispensing device according to claim 1, further comprising a plant seed.

14. The substance dispensing device according to claim 13, wherein said plant seed is on an exterior surface of said device.

15. The substance dispensing device according to claim 13, wherein said plant seed is within an interior portion of said device.

16. The substance dispensing device according to claim 1, wherein said substance comprises a polyacrilamide gel.

17. The substance dispensing device according to claim 1, wherein said substance comprises a polyacrilamide gel and a fertilizer.

18. The substance dispensing device according to claim 1, wherein said substance comprises a polyacrilamide gel and an insecticide.

19. The substance dispensing device according to claim 1, wherein said substance comprises a polyacrilamide gel and a fungicide.

20. The substance dispensing device according to claim 1, wherein said substance comprises a polyacrilamide gel and an herbicide.

21. The substance dispensing device according to claim 1, wherein said biodegradable member is perforated.
